(19) United States
(12) Patent Application Publication
(10) Pub. No.: US 2014/0032797 A1
(43) Pub. Date: Jan. 30, 2014

(54) METHOD FOR REPLACING A SIGNAL BOX, CONNECTED TO AN ELECTRONIC SIGNAL BOX, HAVING A RELAY INTERFACE INPUT/OUTPUT, WITH A FURTHER ELECTRONIC SIGNAL BOX HAVING AT LEAST ONE DATABUS INPUT/OUTPUT, AND ELECTRONIC SIGNAL BOX

(71) Applicant: Thomas Vierling, Braunschweig (DE)

(72) Inventor: Thomas Vierling, Braunschweig (DE)

(73) Assignee: Siemens Aktiengesellschaft, Munchen (DE)

(21) Appl. No.: 14/112,599

(22) PCT Filed: Apr. 3, 2012
(86) PCT No.: PCT/EP12/56089

§ 371 Date: Oct. 18, 2013

(30) Foreign Application Priority Data
Apr. 18, 2011 (DE) 10 2011 007 601.8

(51) Int. Cl. G06F 13/10

(52) U.S. Cl. CPC G06F 13/10
USPC 710/36

(57) ABSTRACT

In order to be able to replace a first signal box, connected to an electronic second signal box, in relay engineering with a further electronic third signal box in a time- saving fashion, the electronic second signal box used is an electronic second signal box having such generic functionality for its inputs/outputs that setting up a databus connection between the databus input/output of the further electronic third signal box and a databus input/output of the electronic second signal box involves a databus input/output of the electronic second signal box being activated and the relay interface input/output thereof being deactivated. An interruption of the databus connection involves the databus input/output of the electronic second signal box being deactivated and the relay interface input/output thereof being activated.

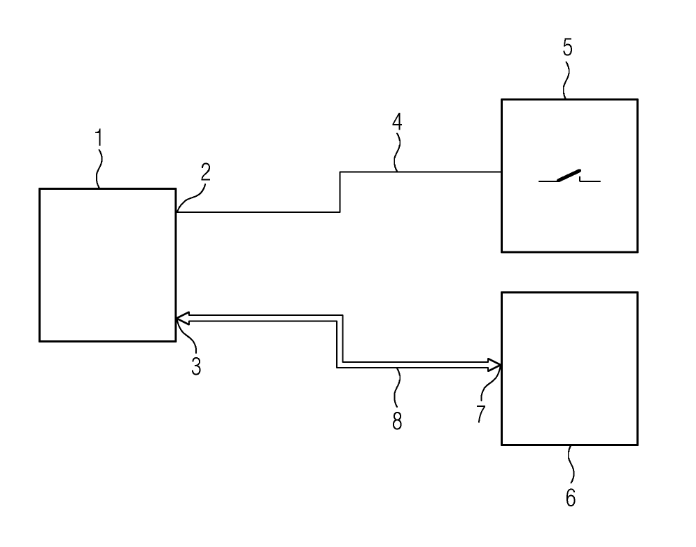

Method for replacing a signal box, connected to an electronic signal box, having a relay interface input/output, with a further electronic signal box having at least one databus input/output, and electronic signal box

The trend in technical development, in order to manage rail traffic, lies increasingly in replacing signal boxes of an older model designed to use relays with electronic signal boxes. The electronic signal boxes are provided with a databus input/output, so that they can communicate with similar signal boxes. The electronic signal boxes are also further equipped with a relay interface input/output so as to enable their use also in conjunction with an older signal box in terms of relay design. This requires special software for the two different inputs/outputs respectively.

If a signal box using relay technology is connected to an electronic signal box and is to be replaced with an electronic signal box, then this requires special measures during the commissioning of the new electronic signal box because the commissioning of the new electronic signal box cannot be implemented abruptly, but the necessary more complex tests must be performed in a longer, complicated process during ongoing operation. It is consistently necessary to switch off the signal box in using relay technology and to switch on the new electronic signal box and vice versa. This requires deactivation of the software of the relay interface input/output and activation of the software of the databus input/output of the one electronic signal box and vice versa, in other words a “start-up and power-down” of the signal box program.

The object underlying the invention is to create here options and to propose a method for replacing a signal box connected to an electronic signal box having relay input/output with a further electronic signal box having at least one databus input/output with which replacement is performed in a time-saving fashion.

In order to achieve this object, a method is used in accordance with the invention to replace a signal box, having a relay interface, connected to an electronic signal box having a relay interface input/output and a databus input/output with a further electronic signal box having at least one databus input/output, in which an electronic signal box with a generic functionality for its inputs/outputs is used as the one electronic signal box such that when a databus connection is established between the databus input/output of the further electronic signal box and the databus input/output of the one electronic signal box of the databus input/output, this one electronic signal box is activated and its relay interface input/output is deactivated and when the data bus connection is interrupted, the databus input/output of the one electronic signal box is deactivated and its relay interface input/output is activated.

One essential advantage of the inventive method consists in this one electronic signal box being deactivateable on account of the one electronic signal box with a generic functionality for its input/outputs solely by establishing the data connection to the new electronic signal box by way of the databus input/output of the relay interface input/output and the relay input/output being reactivateable on account of triggering the data connection.

The object underlying the invention is further to propose an electronic signal box that enables a time-saving replacement of a connected signal box using relay technology with a further electronic signal box.

In order to achieve this object, provision is made in accordance with the invention for an electronic signal box having a relay interface input/output and a databus input/output with a generic functionality of this type for its inputs/outputs, such that when a databus connection is established between the databus input/output of a further electronic signal box and its databus input/output, its databus input/output is activated and its relay interface input/output is deactivated and when the databus connection is interrupted, its databus input/output is deactivated and its relay interface input/output is activated.

Reference is made to the above execution of the inventive method in respect of the achievable advantages.

For further explanation of the invention, the FIGURE shows an arrangement with a number of schematically represented signal boxes, said arrangement being suited to explaining the method according to the invention.

An electronic signal box 1 is shown in the Figure, which comprises a relay interface input/output 2 and a databus input/output 3. The electronic signal box 1 is connected to a signal box 5 using relays by way of a communication connection 4.

The FIGURE further shows a further electronic signal box 6, which is provided with a databus input/output 7. This further electronic signal box 6 is to be replaced with the signal box 5 using relays, so that instead of the signal box using relays, only the further electronic signal box 6 is connected to the one electronic signal box 1 by way of a databus 8.

In order to achieve this, the one electronic signal box 1 is equipped with a generic functionality for its input/outputs 2 and 3 such that when connecting the data bus 8 to the databus input/output 3, the relay interface input/output 2 of the electronic signal box is automatically deactivated and the databus input/output is activated. In railroad traffic non-operational periods, tests can then be implemented with the further electronic signal box 6 way of the databus 8. When the respective non-operational period is ended, this input/output can be deactivated and the relay interface input/output 2 can be automatically activated by releasing the databus 8 from the databus input/output 3.

1-2. (canceled)

3. A method for replacing a first signal box having relays and, connected to an electronic second signal box having a relay interface input/output and a databus input/output, with a further electronic third signal box having at least one databus input/output, which comprises the step of:
setting up the electronic second signal box with generic functionality such that when a databus connection is established between the databus input/output of the further electronic third signal box and the databus input/output of the electronic second signal box, the databus input/output of the electronic second signal box being activated and the relay interface input/output being deactivated and when the databus connection is interrupted, the databus input/output of the electronic second signal bus being deactivated and the relay interface input/output being activated.

4. An electronic signal box, comprising:
a relay interface input/output; and
a databus input/output, the electronic signal box having a generic functionality for said relay interface input/output and said databus input/output such that when a databus connection is established between a databus input/output of a further electronic signal box and said databus input/output of the electronic signal box, said databus input/output is activated and said relay interface input/output is deactivated and when the databus connection is interrupted, said databus input/output of the electronic signal box is deactivated and said relay interface input/output is activated.

5. A communication system, comprising an electronic first signal box having a relay interface input/output and a databus input/output with generic functionality for said relay interface input/output and said databus input/output;
a electronic second signal box having a databus input/output; and
a databus connected between said electronic first and second signal boxes such that when a databus connection is established between said databus input/output of said electronic second signal box and said databus input/output of said electronic first signal box, said databus input/output being activated and said relay interface input/output being deactivated and when the databus connection is interrupted, said databus input/output of said electronic first signal box being deactivated and said relay interface input/output being activated.
